(19) United States
(12) Patent Application Publication
(10) Pub. No.: US 2011/0231299 A1
(43) Pub. Date: Sep. 22, 2011

(54) System for hedging of financial risk posed by changes in public policy

(76) Inventor: Philip Martin Pidot, New York, NY (US)

(21) Appl. No.: 13/069,069

(22) Filed: Mar. 22, 2011

Related U.S. Application Data
(60) Provisional application No. 61/316,364, filed on Mar. 22, 2010.

(51) Int. Cl. G06Q 40/00

(52) U.S. Cl. 705/37

(57) ABSTRACT

The invention provides a manner of hedging or protecting against a perceived adverse financial impact associated with the occurrence or non-occurrence of prospective future changes in public policy, including—but not necessarily limited to—enactment of federal, state or local legislation; regulatory decisions; and the disposition of civil and criminal court proceedings. The machine-based implementation of the invention includes an electronic exchange platform that facilitates trading of financial contracts, whose values are derived from the occurrence or non-occurrence of specific political outcomes, via a simultaneous double auction market.

### CROSS-REFERENCE TO RELATED APPLICATIONS

This application claims the benefit of U.S. Provisional Patent application #61316364 entitled “System for hedging of financial risk posed by changes in public policy” which was filed Mar. 22, 2010 on behalf of the same inventor. The entirety of the aforementioned application is herein incorporated by reference.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

1. Field of the Invention

The invention generally concerns methods to facilitate the management, offsetting, or hedging of exogenous financial risk incurred by operators of or investors in business entities and, more particularly, methods to facilitate management of risk associated with unknown future public policy events, including—but not necessarily limited to—enactment, amendment, or repeal of legislation; issuance of regulatory decisions, rules, and pronouncements; and the dispositions of civil and criminal court proceedings.

Political outcomes present significant financial uncertainty to businesses and their stakeholders. Unlike other categories of external financial risk, like changing interest rates and commodity prices, uncertainty about future public policy changes cannot be reliably hedged using existing methods. The ability to reliably offset financial exposure to such outcomes should enable businesses and investors to improve financial forecasting, reduce earnings volatility, lower the cost of capital, and increase risk-adjusted returns.

2. Description of the Prior Art

While the significance of the financial impact of political outcomes is widely and increasingly recognized by operators of businesses in highly regulated industries and financial market participants, no US-based, commercial political futures market is known to exist. A variety of academic, research, and entertainment-focused “prediction markets” (some of which trade real-money-denominated products) have offered users the ability to place small bets on future events, including political outcomes.

The following two tables summarize the known prior art, referenced in U.S. patent documents and external sources.

U.S. PATENT DOCUMENTS

| Reference | | |
|---|---|---|
| Number | Inventor | Notes |
| 2009/0076974 | Berg, Henry et al. | See FIG. 13 for steps 1300, 1302, 1304, 1306, |
| | | 1308. |
| 2009/0030822 | Cresswell, Mark G. | Note paragraph [0081] discussing the multiple |
| | | types of risks, including political. |
| 2009/0024504 | Lerman, Kevin et al. | Note paragraph [0057] discussing purchase of |
| | | shares for the outcome of a political event. |
| 2008/0306776 | Fell, Robert M. et al. | Note paragraph [0052] discussing impending |
| | | regulatory legislation. |
| 2008/0249952 | Benteler, Henry | Note paragraph [0021] discussing computers |
| | | connected by telecommunications network 2. Note |
| | | paragraph [0032] discussing analysis data for |
| | | portfolios maintained on the system. |
| 2008/0133430 | Horowitz, Kenneth A. | General Background. |
| 2008/0040257 | Nafeh, John et al. | Note paragraph [0014] discussing how contract |
| | | payoffs depend on economic and political events. |
| | | Note paragraph [0056] discussing the payoffs for |
| | | different outcomes. |
| 2007/0250429 | Walser, Bryan et al. | See abstract and Figures. |
| 2006/0129470 | Bredgen, Stefan | Note paragraph [0034]-[0035] discussing how data |
| | | fields 230 and 240 store the expiration time and the |
| | | value of futures contracts, respectively. |
| 2004/0015376 | Zhu, Kai et al. | Note paragraph [0044] discussing a change in tax |
| | | rate. |
| 2003/0088495 | Gilbert, Andrew C. et al. | See FIG. 6 for display window 600. Note |
| | | paragraphs [0056]-[0067] discussing components |
| | | of the display window. |
| 2002/0087447 | McDonald, Roy K. et al. | Note abstract and paragraph [0068] discussing |
| | | investing based on a piece of legislation being |
| | | passed or not. |
| 7,363,272 | Braig, Kevin P. et al. | General Background. |
| 7,031,938 | Fraivillig, James et al. | See column 10, lines 6-47. |
| 6,390,472 | Vinarsky, Michael A. | See column 5, lines 27-41. |
| 6,321,212 | Lange, Jeffrey | General background. |

OTHER PRIOR ART

| Author | Publication Information |
|---|---|
| Brunker, | “http://www.msnbc.msn.com/id/5943565/ |
| Mike | |
| University of | http://www.biz.uiowa.edu/iem/markets/fedpolicyb.html |
| Iowa, | |
| College of | |
| Business | |
| Trade | http://intrade.com/v4/markets/?eventClassId=19 |
| Exchange | |
| Network | |
| Limited | |
| Passmore, | http://ieeexplore.ieee.org/stamp/stamp.jsp?arnumber=1358233&isnumber=29802 |
| D. L.; | |
| Cebeci, | |
| E. D. | |

### BRIEF SUMMARY OF THE INVENTION

The present invention enables hedging of political risk by facilitating the purchase and sale of binary futures contracts among market participants on an electronic, internet-based exchange platform, the implementation of which involves systems of computer hardware and software that include user interfaces, databases, algorithms, and protocols necessary to operate and oversee a reliable, secure, and legally compliant market.

Each contract traded on the exchange pertains to a specific prospective public policy outcome. The payout value of a given contract depends on the occurrence or non-occurrence of the corresponding outcome, on or before a pre-determined expiration date. Should the corresponding outcome occur, the contract's payout value upon settlement will be equal to its stated notional value; in all other cases, the payout value will be zero.

Market participants are able to buy and sell both long and short (negative) positions in listed contracts via a simultaneous double auction, consisting of offers to buy or sell some number of contracts at, above, or below a stated price and pursuant to other order conditions, similar to the auction methods employed by existing securities and derivatives markets.

By purchasing and holding until expiration a number of contracts whose aggregate notional value is equal to the financial exposure (or some portion thereof) believed to be inherently incurred by a market participant to the corresponding outcome, such participant can reliably eliminate part or all of the perceived financial risk of an adverse event, instead incurring the known fixed cost of purchasing the necessary contracts. Similarly, market participants with or without inherent exposure to the corresponding outcomes may pursue speculative or arbitrage trading strategies, in an attempt to profit from perceived mispricing of contracts by the market at large (i.e. instances in which participants believe the likelihood of an outcome is greater or less than the likelihood implied by the prevailing market price).

### BRIEF DESCRIPTION OF THE SEVERAL VIEWS OF THE DRAWING

Not applicable

### DETAILED DESCRIPTION OF THE INVENTION

In operating an electronic exchange that enables trade of contracts whose payout values are tied to unknown future public policy outcomes, the sponsors of the exchange (at times in conjunction with third parties) will maintain 1) a system of computer hardware and software necessary to facilitate order submission, matching, clearing, auditing, reporting, and administrative functions (described in further detail below) and 2) a set of rules, protocols, and terms of use in order to promote transactional integrity, address and settle disputes, and comply with relevant laws and regulations.

At any given time during operation of the exchange, some number of active binary contracts will be listed for trade, each of which will correspond to the occurrence or non-occurrence of a single, objectively testable public policy outcome on or before a pre-determined expiration date. From time to time, as warranted by political developments and market demand, new contracts will be launched, with their relevant details (including the explicit rules defining the underlying triggering outcome, the expiration date, and the notional value per lot) disseminated via the website through which the platform is primarily accessed. When a contract reaches its expiration date, it is removed from the roster of active contracts.

According to rules detailed on the exchange website, each outcome will be judged to have occurred or not occurred on or before its expiration date, at the discretion of the sponsors of the exchange. Should an outcome be judged to have occurred on or before the expiration date of the corresponding contract, a holder of a long position in such contract will receive a cash payout equal to the contract's notional value. Should an outcome be judged not to have occurred by its expiration date, a holder of a long position in such contract will receive no cash payout. The date of the determination of an outcome's occurrence or non-occurrence constitutes the settlement date of the corresponding contract.

At any time after the launch of a new contract and before its settlement date, market participants may trade such contract with other market participants, by submitting bid or ask (buy or sell) offers through one or more internet-based interfaces, including desktop Internet browsers, mobile and other devices capable of displaying HTML websites or mobile applications, application programming interfaces (APIs), and similar methods for manual, automated, and programmatic or rule-based order entry. Market participants are not compelled to hold positions until expiration or settlement, but may sell them back into the marketplace at any time, assuming interested buyers exist. Prior to a contract's expiration date, it can be expected to trade at a price anywhere between $0 and its notional value, depending on the aggregate expectations of market participants as to the likelihood of the occurrence of the underlying outcome, as expressed through their buying and selling activity.

A bid or an offer order specifies the contract to be traded, the number of such contracts to be bought or sold (the lot size), the highest or lowest acceptable execution price (for a bid or offer order, respectively), referred to as the limit price, and, in some cases, additional order instructions.

A bid and an offer order may be matched to each other by the exchange platform when the maximum/minimum execution prices of both orders are satisfied, though not necessarily requiring coincident lot sizes. Unless otherwise specified by the market participant, an order may be partially matched and/or matched against multiple orders submitted by any number of other market participants, sufficient to satisfy part or all of the desired lot size. When multiple satisfactory matches exist, higher bids (and lower offers) will be matched before lower bids (higher offers). For orders with identical limit prices, orders will be matched in the chronological order in which they were received by the exchange platform. The automated matching of bids and offers will proceed continuously in real-time, such that the highest bid price will remain below the lowest offer price.

Upon matching of a bid and an offer order, details of the resulting trade are transmitted to a clearinghouse, enabling the reduction of counterparty credit risk, ensuring smoother market functioning, increasing market transparency, and complying with current and proposed federal financial regulations. Upon confirmation of the clearing of a matched order, the clearinghouse becomes the central financial counterparty to each market participant.

The machine-based implementation of the exchange platform and its associated computer systems include:
Graphical user interfaces and APIs to facilitate manual and automated order entry and other account transactions, review of account holdings and other account information, access to historical price and volume data for contracts traded on the exchange platform, proprietary and third party research and community-generated content related to the likelihood and timing of the outcomes underlying traded contracts;
A graphical user interface used to collect personal and financial data for prospective market participants to enable automated and manual verification of eligibility in accordance with applicable laws and exchange rules;
A simultaneous double auction market algorithm used to match bid and ask orders and to record and display price and volume data to market participants and administrators;
Databases to record and display the cash and contract holdings and account activity of market participants;
Machine-based pattern matching tools intended to identify proscribed trading activity such as trading by ineligible participants and trading by participants with material, non-public information concerning the likelihood and/or timing of outcomes underlying traded contracts; attempts to manipulate trading prices; and other trading activity that may be prohibited by law and/or exchange rules; and
Computer programs and systems that facilitate transmission of data to and from the computer systems of market participants' third party financial institutions and the exchange's third party clearinghouse.

1. A method and machine-based implementation for facilitating among a group of eligible participants the reliable management, hedging, or offsetting of perceived financial risk associated with unknown future public policy events, comprising the steps of:
operating and maintaining an electronic trading platform and marketplace (in compliance with U.S. laws and regulations) that employs a continuous double auction method to enable the ongoing purchase and sale of futures contracts with binary payout values tied to the occurrence or non-occurrence of corresponding policy outcomes;
employing a derivatives clearinghouse as the central counterparty to each trade, thus reducing counterparty risk and promoting smooth market functioning; and
identifying through any appropriate means those unknown policy outcomes likely to pose significant and widespread financial risk and structuring corresponding traded contracts so as to capture that risk.
